(19) United States
(12) Patent Application Publication
(10) Pub. No.: US 2020/0165849 A1
(43) Pub. Date: May 28, 2020

(54) Hinge for Detachable Sheet Metal Cabinet Doors or Walls

(71) Applicant: DIRAK Dieter Ramsauer Konstruktionselemente GmbH, Ennepetal (DE)

(72) Inventors: Cem Olkay, Witten (DE); Peter Höschler, Velbert (DE)

(21) Appl. No.: 16/638,255

(22) PCT Filed: Aug. 2, 2018
(86) PCT No.: PCT/EP2018/070997

§ 371 Date: Feb. 11, 2020

(30) Foreign Application Priority Data
Aug. 12, 2017 (DE) 20 2017 004 239.8

(51) Int. Cl. E05D 3/02; E05D 7/10

(52) U.S. Cl. CPC E05D 3/02; E05Y 2600/632; E05Y 2900/208; E05D 7/1061

(57) ABSTRACT

After the claims, please insert a page containing the Abstract of the Disclosure which is attached hereto as a separately typed page.

The invention relates to a hinge for detachable sheet metal cabinet doors or walls, comprising a first hinge part or frame hinge part that can be attached to the door or cabinet frame and a second hinge part or door hinge part that can be fixed to the door leaf or cabinet wall, which hinge parts are connected to one another by means of a hinge pin in an articulated manner, and having a latch-type tongue that is arranged in the second hinge part such that it can move against a spring force, which encompasses the hinge pin guided through the finger-type ends of the first hinge part and centrally supports the hinge pin together with the hook formed by the door part.

Such a hinge arrangement for detachable sheet metal cabinet doors or walls is already known from German utility model specification DE 20 2015 001 918 U1. This hinge and also other known hinges are suitable for combining a hinge and closing function, in order to allow provision of flexible options such as a change of hinge side and/or locking side.

The intention is to improve on the prior art such that an additional lifting and pressing function adds a further closing function to the already known hinges in a field of application.

The object is achieved in that a lifting device is provided which, by means of a key, such as a double bit key, via an actuator moves the encompassing part of the second hinge part perpendicularly to the plane of the door leaf or the cabinet wall, to which the hinge is attached or screwed.

The lifting device advantageously forms coulisse-like guide walls for which the external walls of the lifting device constitute a guide and encompass these in a U-shaped manner.

The external walls form feet, with which they are attached to the door leaf, so that as the external walls are raised and lowered, a raising and lowering of the door leaf or the cabinet wall is achieved.

The coulisses support a turntable provided in the foot region with a helical track, in which helical track a projection is inserted, which protrudes from the bottom of the actuator.

The projection is formed by a head screw, which is screwed into the bottom of the actuator. This facilitates mounting of the arrangement. In order to be able to perform both movements, namely on the one hand the lifting of the walls and on the other hand the moving of the tongue, independently of one another, the tongue has an L-shaped cutout, through which a pin arranged in the walls is provided, which guides the tongue upon rotation of the actuator such that upon rotation through 180° in a first direction (e.g. clockwise direction or right rotation) the walls are raised, and that by rotation through a further 180° in the same direction (clockwise direction) the tongue is drawn into the coulisses.

The leg direction of the L-shape determines the movement of the tongue parallel and perpendicularly to the door leaf plane. A hinge, driven by a suitable key in a rotatable actuator accessible from the outside, a coulisse of the hinge, performs a lifting or pressing movement away from or towards the frame part, without affecting the hinge function. This is achieved by a pin that sits in the door part, which engages in a curved track located on the outer periphery of the actuator thereby allowing the lifting or pressing movement. The turntable in conjunction with carrier and spacer ensures that only after the lifting movement the latch or the tongue can be retracted by a further rotational movement of the key and thus a separation of the hinge is caused and the hinge function is inhibited. The latch or the tongue is also provided with an override and has a spring force such that the closing operation can be carried out without a key.

In addition to the already known hinge and closing function the lifting and lowering function of the novel hinge allows the closing comfort at sealing pressure to be significantly increased and/or a pressure relief prior to the opening process to be ensured. This also allows a possible safety issue to be addressed at corresponding internal housing pressure or enables a compression of the seal appropriate for the class of protection.

The invention is now explained in more detail using exemplary embodiments which are shown in the drawings.

These show as follows:

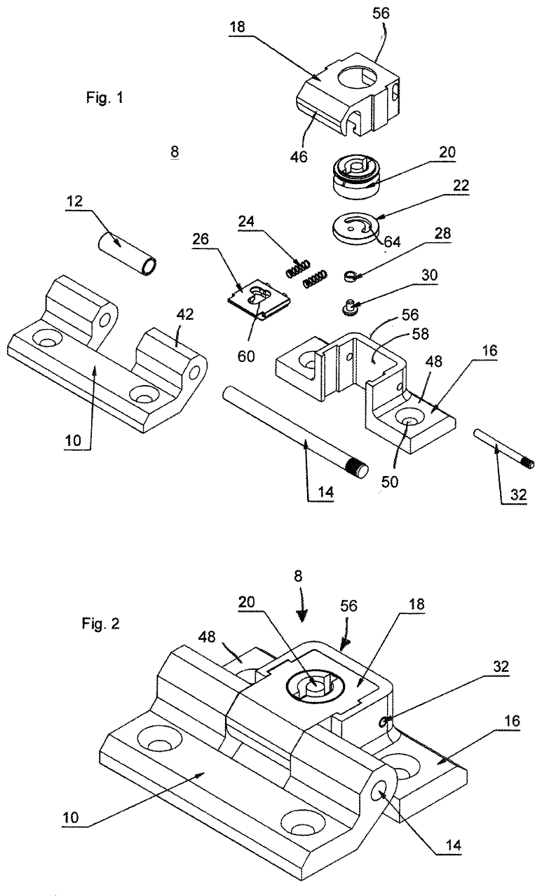

FIG. 1 the individual parts of the hinge according to the invention in exploded view;

FIG. 2 the hinge in the assembled state with the individual parts of FIG. 1, wherein the hinge is in the rest position;

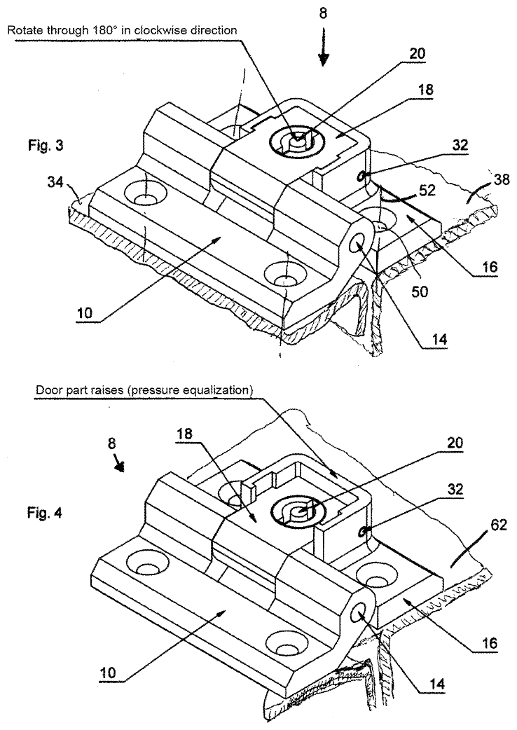

FIG. 3 the hinge after mounting in a sheet metal cabinet in the rest position, in a representation similar to FIG. 2;

FIG. 4 the hinge with the door part raised after a rotation through 180°;

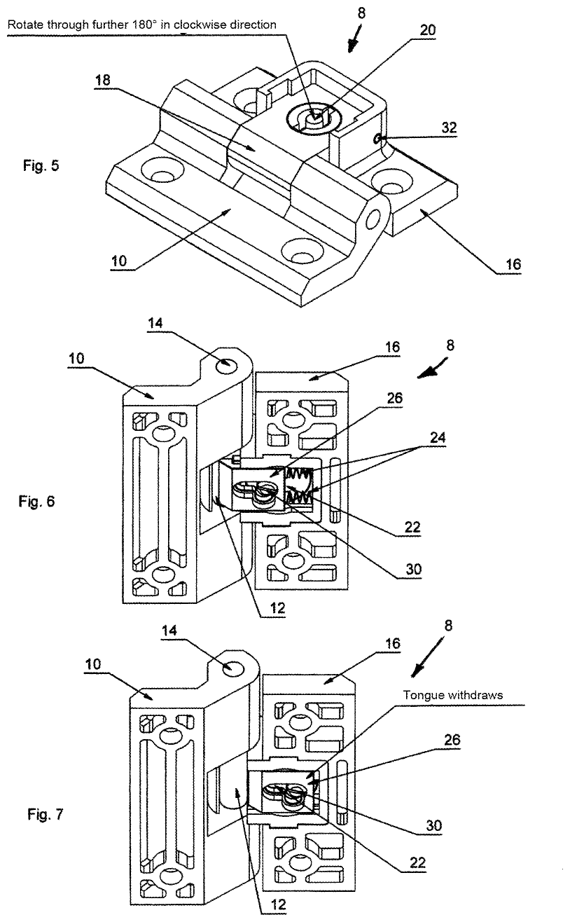

FIG. 5 a perspective view of the hinge following an initial use before the further rotation through 180° in the clockwise direction for moving out through pulling of the tongue;

FIG. 6 the state with the tongue advanced (hinge function);

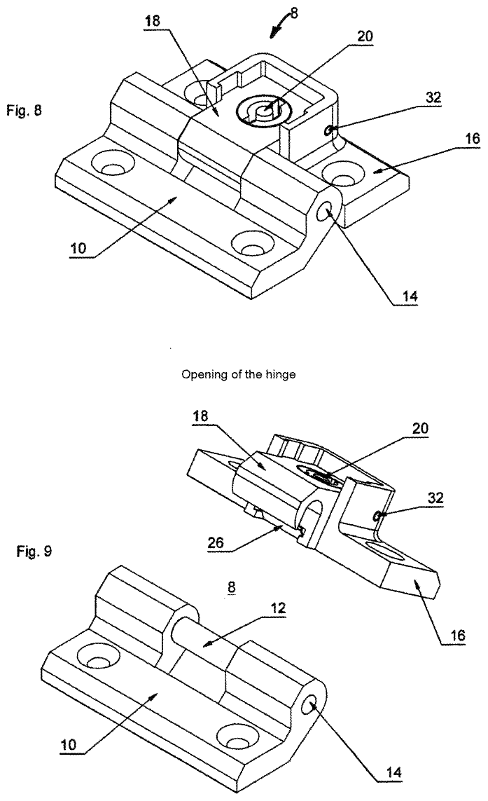

FIG. 7 the state with the tongue retracted (hinge parts can be separated);

FIG. 8 a top view of the hinge according to the invention in the lowered position;

FIG. 9 the hinge of FIG. 8 following separation into the two hinge parts;

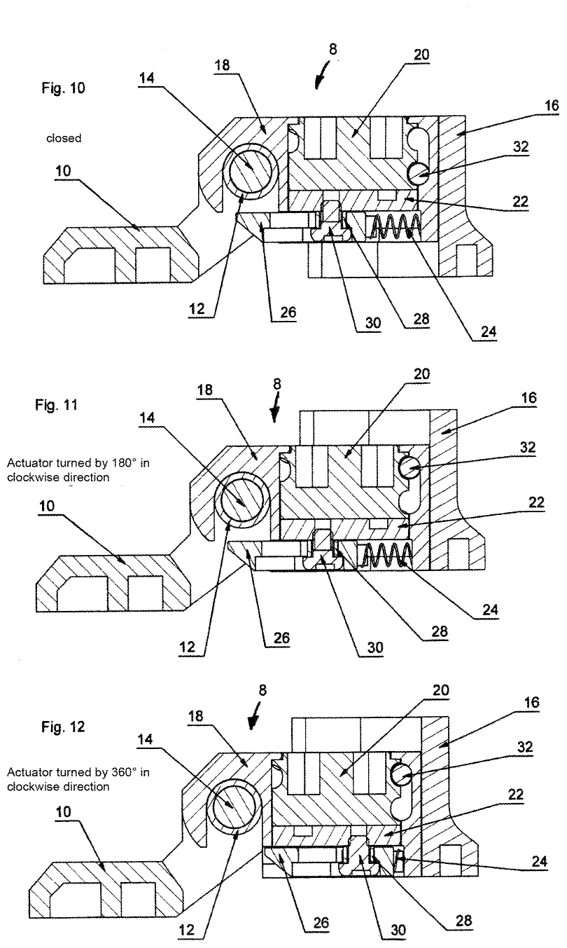

FIG. 10 a cross-sectional view of the hinge according to the invention in the closed position (hinge function);

FIG. 11 a similar view to FIG. 10 in the lowered position following rotation through 180°;

FIG. 12 the position following rotation through 360°;

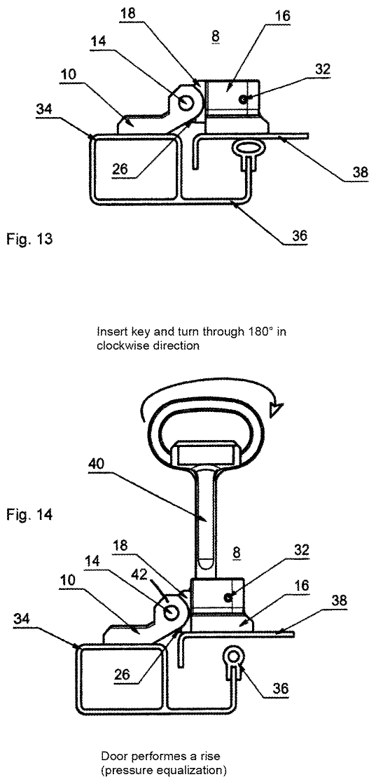

FIG. 13 a side view of the hinge mounted on the switch cabinet with seal;

FIG. 14 the arrangement of FIG. 13 following insertion of an actuator key and clockwise rotation of this through 180° (door lifts) (pressure equalization, seal is relaxed);

FIG. 15 A an enlarged representation of the tongue in the locking position;

FIG. 15 B a similar view to FIG. 13 representing the internal arrangement of the hinge;

FIG. 16 A a similar view to FIG. 15 A, but with the tongue retracted;

FIG. 16 B a similar view to FIG. 15 A of the state of FIG. 16 A;

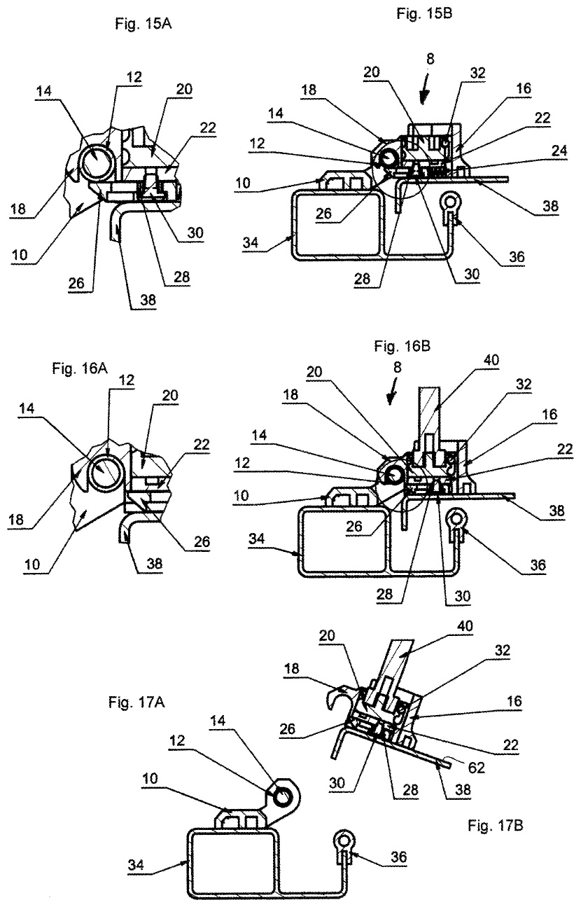

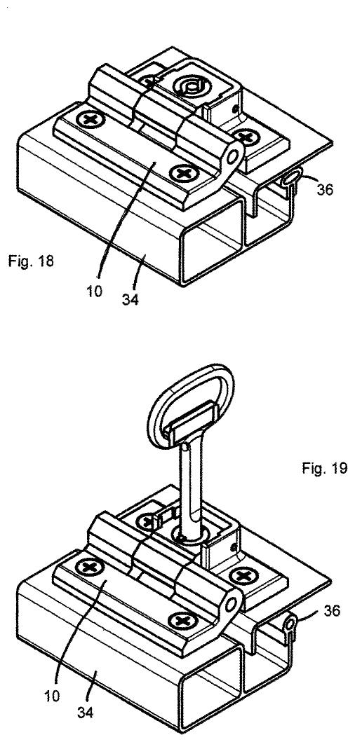

FIG. 17 A and FIG. 17 B a similar view to FIG. 16 B, but with the hinge taken apart;

FIG. 18 a perspective view of the mounted and closed hinge;

FIG. 19 a perspective view of the mounted and relaxed hinge with key inserted;

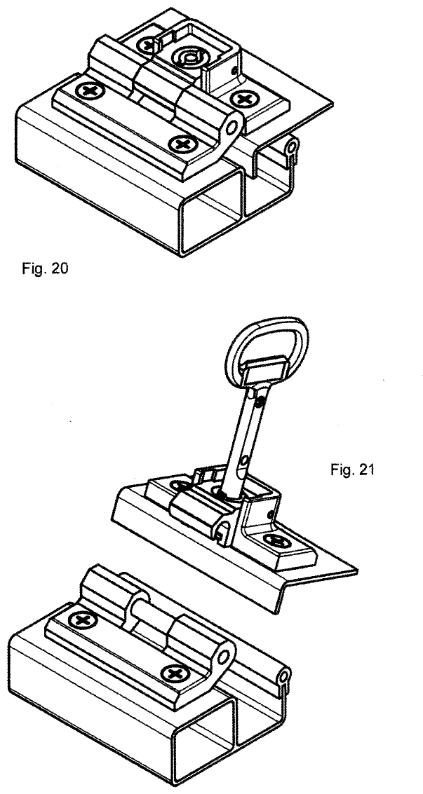

FIG. 20 the hinge in the mounted and relaxed position without key;

FIG. 21 the mounted hinge following separation of the hinge parts;

FIG. 22 a side view of the hinge in the hinge function; and

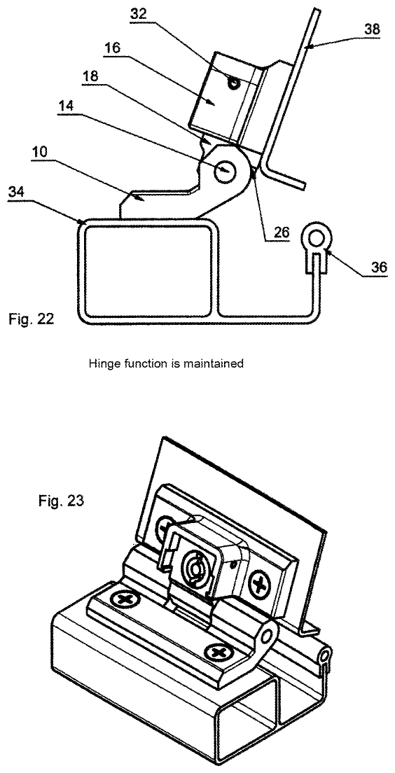

FIG. 23 a perspective representation of the hinge of FIG. 22.

In FIG. 1 an exploded view of the hinge 8 according to the invention is illustrated, while FIG. 2 illustrates the assembled hinge 8 and FIG. 3 the hinge 8 after mounting in a door

The hinge according to the invention for detachable sheet metal cabinet doors or walls, comprises a first hinge part or frame part 10 that can be attached to the door or cabinet frame 34, and a second hinge part 16 or door hinge part that can be fixed to the door leaf or cabinet wall 38, which hinge parts 10, 16 are connected to one another in an articulated manner by a hinge pin 1, and having a latch-type tongue 26 that is arranged in the second hinge part 16 such that it can move against a spring force 24, a lifting device 18, which encompasses the hinge pin 14 guided through the finger-type ends 42 of the first hinge part 10 and which centrally supports the hinge pin together with a hook 46 formed by the door part 16, the lifting device 18 moves the encompassing part or hook of the second hinge part 16 perpendicularly to the plane 62 of the door leaf or cabinet wall 16 by means of a key 40, such as a double bit key, via an actuator 20.

The door hinge part 16 forms coulisse—like guide walls 56, 58, which provide a guide for the lifting device 18 and encompass this in a U-shaped manner.

The lifting device 18 supports the key housing 20 and the turntable 22 has a helical track 64 in which a projection is inserted which protrudes from the bottom of the actuator 20.

The projection is formed by a head screw 30, which is screwed into the bottom of the actuator. This facilitates mounting of the arrangement in its movement. In order to be able to perform both movements, namely on the one hand the lifting of the coulisses and on the other hand the moving of the tongue independently of one another, the tongue 26 has an L-shaped cutout 60, which guides the tongue upon rotation of the actuator such that upon rotation through 180° in a first direction (e.g. clockwise direction or right rotation) the coulisses are raised, and that by rotation through a further 180° in the same direction (clockwise direction) the tongue is drawn into the coulisses (see FIGS. 10, 11, 12).

This results in a hinge 9, which driven by a suitable key 40 in a rotatable actuator 20 accessible from the outside, allows a coulisse of the hinge to perform a lifting or pressing movement 18 away from or towards the frame part, without affecting the hinge function. This is achieved by a pin 32 sitting in the door part, which engages in a curved track located on the outer periphery of the actuator and thus allows the lifting or pressing movement. The turntable 22 in conjunction with carrier and spacer 28 ensures that only after the lifting movement the latch 26 can be retracted by a further rotational movement of the key and thus a separation of the hinge is caused, and the hinge function is inhibited. The tongue is also provided with an override so that supported by a spring force the closing operation can be carried out without a key.

### LIST OF REFERENCE NUMERALS

8 Hinge
10 Frame part, first hinge part
12 Spacer roller
14 Dowel pin 6×80
16 Door part, second hinge part
18 Coulisse
20 Actuator
22 Turntable
24 Spring 0.25×3.2×20.7
26 Tongue
28 Spacer
30 Screw
32 Dowel pin 3×34
34 Door frame
36 Seal
38 Door leaf
40 Double bit key
42 Finger-type ends
44 Actuator
46 Hook
48 Feet
50 Bore hole
52 Screw
54 Leg
56 Guide wall of the lifting device
58 Inner wall
60 L-cutout
62 Door leaf plane

1. A hinge for detachable sheet metal cabinet doors or walls, comprising a first hinge part or frame part that can be attached to the door or cabinet frame, and a second hinge part or door part that can be fixed to the door leaf or cabinet wall, which hinge parts are connected to one another in an articulated manner by means of a hinge pin, and having a latch-type tongue that is arranged in the second hinge part such that it can move against a spring force, characterised by a lifting device, which encompasses the hinge pin guided through finger-type ends of the first hinge part and which centrally supports the hinge pin together with the latch-type tongue, and that the lifting device moves the encompassing part of the second hinge part perpendicularly to the plane of the door leaf or cabinet wall, by means of a key, such as a double bit key, via an actuator.

2. The hinge according to claim 1, characterised in that the lifting device
forms coulisse-like guide walls, which constitute a guide for inner walls of the lifting device and encompass these in a U-shaped manner.

3. The hinge according to claim 2, characterised in that the walls form feet, with which they are attached to the door leaf.

4. The hinge according to claim 2, characterised in that the coulisses support a turntable with a helical track in the foot region, in which helical track a projection is inserted, which protrudes from the bottom of the actuator.

5. The hinge according to claim 4, characterised in that the projection is formed by a head screw, which is screwed into the bottom of the actuator.

6. The hinge according to claim 5, characterised in that the tongue upon rotation of the actuator is guided in such a way that upon rotation through 180° in a first direction (e.g. clockwise direction, to the right) the walls are raised, and in that by a further rotation through 180° in the same direction the tongue is drawn into the coulisses.
